(19) United States
(12) Patent Application Publication
(10) Pub. No.: US 2026/0250912 A1
(43) Pub. Date: Aug. 27, 2026

(54) PROCESS FOR PRODUCING A FIBROUS MATERIAL

(71) Applicant: Stora Enso OYJ, Helsinki (FI)

(72) Inventors: Isto Heiskanen, Imatra (FI); Kaj Backfolk, Lappeenranta (FI); Katja Lyytikäinen, Imatra (FI)

(73) Assignee: Stora Enso OYJ, Helsinki (FI)

(21) Appl. No.: 18/874,633

(22) PCT Filed: Jun. 12, 2023
(86) PCT No.: PCT/IB2023/056031

§ 371 Date: Dec. 13, 2024

(30) Foreign Application Priority Data
Jun. 14, 2022 (SE) 2230196-4

(51) Int. Cl. D21H 25/04; D21D 5/02; D21H 11/04; D21H 11/18; D21H 27/10

(52) U.S. Cl. CPC D21H 25/04; D21D 5/02; D21H 11/04; D21H 11/18; D21H 27/10

(57) ABSTRACT

The present invention relates to a process for producing a fibrous material with improved dewatering behavior. The fibrous material produced according to the present invention is useful in the preparation of for example films and coatings. The fibrous material can be produced from a suspension comprising MFC or highly refined pulp, from which a part of the solids is removed, followed by heat treatment carried out on the suspension and/or on a wet web formed from the suspension.

### TECHNICAL FIELD

The present invention relates to a process for producing a fibrous material with improved dewatering behavior. The fibrous material produced according to the present invention is useful in the preparation of, for example, films and coatings.

### BACKGROUND

Films and barrier papers comprising high amounts of microfibrillated cellulose (MFC) are known in the art. Depending on how they are produced, the films may have particularly advantageous strength and/or barrier properties, whilst being biodegradable and renewable. Films comprising MFC are for example used in the manufacture of packaging materials and may be laminated or otherwise provided on the surface of paper or paperboard materials.

One of the advantages of MFC is its ability to hold water. Unfortunately, it is also one of the disadvantages when making a film or barrier or using it in paperboard making. Many solutions have been proposed for improving drainage, such as reduced pH of MFC suspensions, enzyme treatment of MFC to remove hemicellulose, or to fractionate MFC.

Prior art documents further teach that especially when derivatizing i.e. chemically modifying fiber before fibrillation, the obtained fibrils suspensions provides a film with improved barrier properties especially against gases. When preparing a fibril suspension, it is thus advantageous if the suspension contains higher amounts of individual fibrils and substantially no fibers.

Another way to visualize the degree of fibrillation or residual of larger fiber fragments or coarse fibers, is to determine the transparency of the suspension or for example water retention value (WRV), which normally increases (reduced turbidity, increased water retention i.e. water holding capacity).

Although it is evident that higher content of fibrils having nano-dimension would provide better barrier properties, it is obvious that they contribute negatively to drainage resistance, which is a crucial step in forming the barrier layer.

WO2021116988A1 teaches the use of hornificated particles from MFC. Different solutions to dry MFC is presented.

US2021395949A1 is directed to a fractionation method for MFC in order to produce nanocellulose with greater homogeneity in terms of nanofibril size distribution. The invention discloses an option to return fibers to for example first or second defibrillation step.

US2019316293A1 is directed to a method to fractionate suspensions comprising blends of cellulose nano-filaments or cellulose micro-filaments, such as through a dilution-fractionation step. The method may include a washing step prior to the fractionation step, in which said washing can be performed at high or low pH. The document teaches also that the removal of finest fraction has a positive effect on tensile strength, but the document is silent about the role on dewatering/drainage resistance and barrier properties.

Larsson A et al., (Cellulose, 26 (2019), 1565-1575: fractionation of MFC to optimize dewatering time when making films by filtration) teaches the role of fractionation of MFC made from bleached sulphite pulp on e.g. filtration time and mechanical properties of the obtained sheets. Both filtration-based and centrifugation-based techniques were used. With increased concentration of fine MFC, the strength properties were obtained. However, the document emphasizes that there is a significant loss of material during fractionation.

U.S. Pat. No. 9,809,655B2 is directed to modifying nanofibrillar cellulose and to reducing viscosity of said suspension. In one embodiment, the suspension is subjected to heat treatment in the range of 90-180° C. and most preferably 120-140° C., which reduced the zero-shear viscosity. The applicant further claims that it was found that heat-treatment breaks the remaining fiber fragments and changes the gel structure, but also that the size of the fibrils remains unchanged.

### SUMMARY

It has surprisingly been found that the dewatering speed of MFC during MFC film or coating preparation can be significantly improved if the MFC suspension or a wet web formed from the suspension is subjected to at least one heat treatment. An especially surprising effect was obtained if a small fraction of the MFC (fines) was first removed and the MFC was then concentrated, followed by thermal treatment.

Thus, the present invention is directed to a process for preparing a treated fibrous material in the form of a suspension or a wet web comprising the steps of:
a) providing a suspension comprising MFC or highly refined pulp, wherein the MFC or highly refined pulp is at least 50% of the solids of the suspension and wherein the suspension has a dewatering resistance measured as Schopper-Riegler (SR) value according to EN ISO 5267-1 in the range of from 72 to 99 SR°;
b) removing 2 wt-% to 25 wt-% of the solids from the suspension, wherein the content of flake-like fine material having a length less than 0.2 mm in the removed fraction is at least 50%, determined, using a Valmet Fiber Image Analyzer (FS5), as a percentage of the projection area of all measured objects in the removed fraction;
c) adjusting the solid content of the suspension from step b) to at least 2 wt % solid content;
d) subjecting the fibrous material in the suspension from step c) to a heat treatment step wherein the fibrous material in the suspension is subjected to a temperature in the range of from 50 to 150° C. for at least 10 seconds to obtain a treated fibrous material, wherein the heat treatment is carried out on the suspension and/or on a wet web formed from the suspension.

Thus, one aspect of the present invention is the treated fibrous material obtained according to the process of the present invention.

The present invention is also directed to the preparation of a film or coating or paper or paperboard, wherein the treated pulp obtained according to the present invention is optionally diluted and then used to prepare a film or coating or paper or paperboard according to methods known in the art.

Thus, one aspect of the present invention is a film or coating or paper or paperboard prepared using the treated pulp according to the present invention.

### DETAILED DESCRIPTION

The suspension in step a) comprises MFC or highly refined pulp, wherein the MFC or highly refined pulp is at least 50% of the solids of the suspension and wherein said suspension has a Schopper Riegler value (SR°) in the range of from 72 to 99 SR°, such as from 75 to 85 SR°. The Schopper-Riegler value can be determined through the standard method defined in EN ISO 5267-1.

The MFC or highly refined pulp in the suspension can be produced using methods known in the art and may for example be based on kraft pulp, which has been refined to achieve the desired Schopper Riegler value. The pulp may also comprise microfibrillated cellulose (MFC). The pulp may be a mix of essentially unrefined pulp, low-refined pulp, mildly refined pulp and/or moderately refined pulp, mixed with highly refined pulp and/or MFC. The suspension may, in addition to the pulp, comprise additives typically used in papermaking.

The suspension in step a) may comprise a mixture of different types of fibers, such as microfibrillated cellulose, and an amount of other types of fiber, such as kraft fibers, fines, reinforcement fibers, synthetic fibers, dissolving pulp, TMP or CTMP, PGW, recycled fibers/pulp etc. The hemicellulose content of the solids of the suspension in step a) is preferably less than 25 wt-%, more preferably less than 22 wt-%. The hemicellulose content of the solids of the suspension in step a) is preferably at least 2 wt-%, more preferably at least 5 wt-%.

The suspension in step a) may also comprise other process or functional additives, such as fillers, pigments, wet strength chemicals, retention chemicals, cross-linkers, softeners or plasticizers, adhesion primers, wetting agents, biocides, optical dyes, colorants, fluorescent whitening agents, de-foaming chemicals, hydrophobizing chemicals such as AKD, ASA, waxes, resins etc. In one embodiment of the present invention, the suspension in step a) does not contain internal sizing agents, cationic retention and drainage chemicals, cationic fillers or fixatives.

The pH of the suspension in step a) is preferably in the range of from 3 to 9, such as from 4 to 8 or from 4 to 6.

The step of removing 2 wt-% to 25 wt-% of the solids from the suspension of step a), wherein the content of flake-like fine material having a length less than 0.2 mm, in the removed fraction is at least 50%, determined as a percentage of the projection area of all measured objects in the removed fraction, can be carried out using methods known in the art. For example, this step can be carried out by using a belt washer or a washer Vario-Split (Voith GmbH). In a Vario-Split, material such as ash and/or fines can be removed. Preferably, at least 70% of the solids removed is flake-like fine material having a length less than 0.2 mm, determined as a percentage of the projection area of all measured objects in the removed fraction. More preferably, at least 90% of the solids removed is flake-like fine material having a length less than 0.2 mm, determined as a percentage of the projection area of all measured objects in the removed fraction. The characteristics of the fraction removed can be determined using a Valmet Fiber Image Analyzer (Valmet FS5). The flake-like fine material having a length less than 0.2 mm can also be described as “Fines A” when determined using a Valmet Fiber Image Analyzer (Valmet FS5). For the Valmet Fiber Image Analyzer (Valmet FS5), the device version can be version 2.3 and the client version can be 1.86. For the determination of the fraction discussed above, i.e. the “Fines A” fraction, the Valmet Fiber Image Analyzer (Valmet FS5) determines the percentage of the projection area of the measured particles that has the defined length. In one embodiment, the step of removing 2 wt-% to 25 wt-% of the solids from the suspension of step a) can be carried out by filtration.

Preferably, from 2 wt-% to 8 wt-% of the solids are removed in the step of removing a certain fraction of the solids from the suspension of step a). More preferably, from 2 wt-% to 4 wt-% of the solids are removed from the suspension.

The solid content of the suspension in step a) is preferably in the range of from 0.1% to 1.9%, thus 1 kg of the suspension preferably contains 1-19 g solids.

The step of adjusting the solid content of the suspension of MFC or highly refined pulp to at least 2 wt % solid content can be carried out using methods known in the art, such as using a decanter or by filtration, such as filtration using a porous membrane or centrifugation or evaporation to remove liquid from the suspension. Preferably, the solid content is less than 10 wt-%, such as less than 5 wt-%.

The heat treatment in step d) is carried out on the suspension and/or on a wet web formed from the suspension.

In the heat treatment step the fibrous material of the suspension is subjected to a temperature in the range of from 50 to 150° C. for at least 1 minute to obtain a treated pulp. In one embodiment, the suspension is subjected to a temperature in the range of from 60 to 130° C., such as from 70 to 95° C. The duration of the heat treatment is preferably in the range of from 1 to 60 minutes, such as from 5 to 40 minutes or from 10 to 30 minutes. The heat treatment can be carried out using methods known in the art, for example by passing steam through the suspension. In one embodiment, the heat treatment is performed in a pressurized chamber. It has been found that the heat treatment leads to hornification of the fibrils or fibrillated fibers, or parts thereof, of the suspension. The heat treatment may also deactivate microbial activity and enzymes, enabling storage of intermediate products without addition of biocides.

In one embodiment, the heat treatment of the fibrous material in the suspension is carried out on a wet web formed from the suspension. In this embodiment, a wet web is formed by providing the suspension to for example a porous wire or on a non-porous belt to obtain the wet web. The suspension in the form of the wet web obtained, which may have been partly dewatered, such as by pressing, is subjected to the heat treatment, for example by exposing one or both sides of the wet web to steam or using impingement drying or radiation drying, such as drying by using infrared radiation. The solid content of the wet web at the time of the heat treatment is preferably in the range of from 5 wt-% to 98 wt-%, such as from 10 wt-% to 50 wt-% or 10 wt-% to 40 wt-% or 10 wt-% to 30 wt-% or 10 wt-% to 20 wt-%. When steam is used, the temperature of the steam is preferably in the range of from 100 to 150° C., such as from 100 to 120° C. The duration of the heat treatment is preferably in the range of from 10 seconds to 60 minutes, such as from 1 to minutes. Preferably, the grammage of the wet web (based on dry material) is in the range of 5-500 g/m², more preferably 10-200 g/m², most preferably 15-150 g/m².

The heat treatment according to the present invention typically does not change the color or organoleptic properties of the fibrous material.

In one embodiment, the Schopper Riegler value of the heat treated pulp obtained in step d) is at least 2 SR° less than the Schopper Riegler value of the suspension of step c).

The treated pulp obtained according to the process of the present invention can be used according to methods known in the art. For example, the treated pulp can be used in the production of a film or coating or paper or paperboard, for example using a paper machine or using casting.

A wet web of the treated pulp according to the present invention may be formed for example by wet laid or cast forming methods. For wet laid formation, the process may be carried out in a paper making machine such as a fourdrinier or other forming types such as Twin-former or hybrid former. The web can be single or multilayer web or singly or multiply web, made with one or several headboxes.

In the wet laid method, a suspension is prepared and provided to a porous wire. The dewatering occurs through the wire fabric and optionally also in a subsequent press section. Drying is usually done using convection (cylinder, metal belt) or irradiation drying (IR) or hot air. A typical wet laid method is for example the fourdrinier former used in papermaking. In the cast forming method the wet web is formed for example on a polymer or metal belt and the subsequent initial dewatering is predominantly carried out in one direction, such as via evaporation using various known techniques.

The dewatering and/or drying of the web is carried out such that the moisture content at the end of the dewatering and/or drying is preferably less than 50 wt-%, more preferably less than 20 wt-%, most preferably less than 10 wt-%, even more preferably less than 5 wt-%. The product obtained after dewatering and/or drying of the web can be redispersed. After redispersion, the treated and redispersed pulp can be used in a second wet substrate forming, to produce for example a film.

According to a further embodiment of the present invention, there is provided a laminate comprising a paper, paperboard or film prepared using the treated pulp according to the present invention. Such a laminate may for example additionally comprise a thermoplastic polymer (fossil based or made from renewable resources) layer, such as any one of a polyethylene, polyvinyl alcohol, EVOH, starch (including modified starches), cellulose derivative (Methyl cellulose, hydroxypropyl cellulose etc), hemicellulose, protein, styrene/butadiene, styrene/acrylate, acryl/vinylacetate, polypropylene, a polyethylene terephthalate, polyethylene furanoate, PVDC, PCL, PHA, PHB, and polylactic acid. The thermoplastic polymer layer can be provided e.g. by extrusion coating, film coating or dispersion coating. This laminate structure may provide superior barrier properties and may be biodegradable and/or compostable and/or repulpable. According to one embodiment of the present invention, the polyethylene may be any one of a high density polyethylene and a low density polyethylene or mixtures or modifications thereof that could readily be selected by a skilled person. A paper, paperboard or film prepared using the treated pulp according to the present invention can also be part of a flexible packaging material, such as a free standing pouch or bag or be incorporated into for example a box, bag, a wrapping film, cup, container, tray, bottle etc.

Highly refined pulp can be made from unfractionated cellulosic starting material. Highly refined pulp may also be prepared according to methods disclosed in WO2021/001751A. In this embodiment, the highly refined pulp is preferably produced by
a) providing a fine fiber fraction obtained by fractionation of a cellulose pulp;
b) subjecting said fine fiber fraction to refining at a consistency in the range of 0.5-30% by weight to a Schopper-Riegler (SR) number in the range of 80-98, as determined by standard ISO 5267-1, to obtain the highly refined pulp.

The fine fiber fraction used in preparation of the highly refined pulp may for example be obtained by separating the cellulose pulp starting material in pressure screens to achieve a fraction with shorter and thinner fibers. The dry weight of the fine fiber fraction may for example comprise less than 75% by weight, less than 50% by weight, less than 25% by weight of the total dry weight of the unfractionated cellulose pulp starting material used in the preparation of the highly refined pulp.

If a fine fiber fraction is used in preparation of the highly refined pulp, it typically has a mean fiber length of fibers having a length>0.2 mm and below 1.7 mm (as determined according to ISO 16065-2) and a content of fibers having a length>0.2 mm of at least 5 million fibers per gram based on dry weight. The content of fibers having a length>0.2 mm of the fine fiber fraction is typically less than 10 million fibers per gram based on dry weight.

Microfibrillated cellulose (MFC) shall in the context of the patent application mean a cellulose particle, fiber, or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

### EXAMPLES

A highly fibrillated bleached kraft pulp was prepared by low consistency fibrillation of bleached softwood kraft pulp to a drainage resistance of ° SR 95. The fibrillated cellulose was suspended to a consistency of ca 0.1 wt % before making wet substrate or wet films.

The refined pulp was further subjected to fines removal by treating the sample in a DDJ (dynamic drainage jar) equipped with 200 mesh wire which lead to removal of 14 wt-% of fines. When adjusting the pH to 5 before fractionation, the amount of depleted fines were 24 wt %. The removed material was analyzed using a Valmet FS5 Fiber Image Analyzer. It was found that about 94% of the solid material removed was “Fines A”, i.e. flake-like fine material having a length less than 0.2 mm, determined as a percentage of the projection area of all measured objects in the removed fraction.

Fines A and Fines B (lamella-shaped fines, particles with width less than 10 μm and length over 0.2 mm) values of the highly fibrillated bleached kraft pulp were determined with Valmet FS5 Fiber Image Analyzer to be about 47% and 45%, respectively.

30 gsm films were prepared of the obtained suspensions. In the examples below, dewatering time was determined and 30 gsm films were formed as follows:
MFC suspension was diluted to 0.1 wt % consistency with reverse osmosis purified water and subjected to rod mixing (30 s) and magnetic stirring (2 min). 125.6 g of the diluted and mixed suspension was poured into the funnel of a vacuum filtration device equipped with a membrane filter (Durapore®, 0.65 μm pore size). The diameter of the round filtration area was 73 mm. Immediately after pouring the suspension into the funnel, vacuum was switched on and time recording started. The dewatering time(s) recorded during the filtration was the time that was needed for all the visible water to disappear from top of the filtration cake. The wet filtration cake was removed from the filtration device together with the membrane filter and placed in between two blotting papers. The filtration cake (i.e. film) was then couched, subjected to wet pressing at 410 kPa for 5 minutes and dried in a drum dryer at 80° C. for at least 90 minutes. The dried film was weighed after conditioning in 23° C./50% RH. To obtain a specific dewatering value (s/g), the recorded dewatering time(s) was divided by the weight of the dried film (g). Four duplicates were done for each sample.

### Example 1—Comparative

A highly fibrillated cellulose suspension was subjected to rod mixing (2×30 seconds) and dewatered on a membrane to form a wet substrate while the drainage resistance or dewatering time was recorded according to the procedure described above.

### Example 2—Comparative

In this case, the highly fibrillated cellulose suspension was subjected to a dewatering step on a membrane to form a wet substrate, which was then couched between blotting paper. The solid content after blotting is approximately 25-30 wt %. After couching, the wet substrate was redispersed with a rod mixer and subjected to dewatering a second time. Dewatering time during wet substrate forming before couching was measured (“Dewatering time 1”) and also dewatering time (“Dewatering time 2”) during second wet substrate forming after couching and redispersing.

### Example 3—Comparative

In this case, the highly fibrillated cellulose was subjected to two dewatering steps in the same manner as in Example 2, but the couching step was followed by a pressing step, which resembles a mechanical pressure dewatering with a load of about 400 kPa.

### Example 4—Comparative

In this case, the highly fibrillated cellulose was first subjected to fines removal before being subjected to two dewatering steps in the same manner as in Example 3 above following a pressing step.

### Example 5—Comparative

The highly fibrillated cellulose was first subjected to fines removal whereafter the pH of the suspension was reduced to 5 before proceeding in similar manner as in example 4.

### Example 6

The highly fibrillated cellulose was subjected to fines removal before adjusting pH (5) and wet substrate forming. The wet substrate was further press dewatered and then subjected to steam treatment (100-120° C.) for 10 minutes. The wet film was then redispersed before a second wet substrate forming.

### Example 7—Comparative

In this case, the highly fibrillated cellulose was subjected to heat treatment (90° C., 30 min) before being subjected to a first and second dewatering steps following the same procedure as used in Example 3. In this experiment, no removal of fines material was carried out.

### Example 8—Comparative

In this case, the highly fibrillated cellulose was subjected to fines removal and then to heat treatment in the form of a suspension (90° C., 30 min) at 0.15 wt-% solid content before being processed as in Example 7.

### Example 9

In contrary to the process step in example 6, the pH adjustment was implemented before fines removal and subsequent wet substrate forming. After making the wet substrate, the substrate was subjected to steaming (10 minutes, steam temperature 100° C.) before being processed as in Example 6.

### RESULTS

Table I summarizes the impact of the various treatment steps on dewatering or drainage resistance according to the present invention. When normalizing the dewatering time or drainage resistance, it is clear that most efficient treatment is obtained when performing both pH adjustment and fines depletion, following dewatering and steaming which confirms that fibril and fiber properties are changed which is ascribed to wet hornification. The dewatering at the second dewatering phase is significantly improved, confirming the role of both increased solid content and steaming in the hornification, see example 9.

Moreover, sample 6 confirms also that the removal of fines following a pH adjustment and further steaming will reduce dewatering resistance, especially in the second dewatering step.

TABLE I

| | Mixing | Dewatering 1 | Dewatering 2 |
|---|---|---|---|
| | using | @30 gsm, | @30 gsm, |
| Sample | rod mixer | sec/g | sec/g |
| 1 | (2 × 30 sec) | 1596 | |
| 2 | 30 sec | 1523 | 1821 |
| 3 | — | 1325 | 1370 |
| 4 | 10 sec | 1538 | 1440 |
| 5 | 10 sec | 956 | 1056 |
| 6 | 25 sec | 929 | 806 |
| 7 | 10 sec | 1575 | 1557 |
| 8 | 10 sec | 1329 | 1461 |
| 9 | 30 sec | 865 | 629 |

TABLE II
FS5 results for the wet substrates of the Examples above, dispersed in water

| Sample | | 1 | 3 | 5 | 8 | 6 | 9 |
|---|---|---|---|---|---|---|---|
| Fiber length | mm | 0.5 | 0.51 | 0.53 | 0.53 | 0.51 | 0.5 |
| Lc(n) FS5 ISO | | | | | | | |
| Fiber length | mm | 0.76 | 0.75 | 0.76 | 0.78 | 0.76 | 0.75 |
| Lc(I) FS5 ISO | | | | | | | |
| Fiber length | mm | 1.14 | 1.1 | 1.1 | 1.13 | 1.12 | 1.11 |
| Lc(w) FS5 ISO | | | | | | | |
| Fines A FS5 | % | 46.89 | 45.26 | 43.22 | 42.54 | 46.26 | 47.6 |
| Fines B FS5 | % | 45.45 | 54.66 | 55.88 | 55.58 | 56.58 | 54.65 |
| f1(I) FS5 0-0.2 | % | 41.57 | 36.43 | 34.27 | 33.13 | 36.53 | 39.67 |
| mm | | | | | | | |
| f2(I) FS5 0.2-0.6 | % | 29 | 30.9 | 30.7 | 30.6 | 30.63 | 29.9 |
| mm | | | | | | | |
| f3(I) FS5 0.6-1.2 | % | 20.07 | 23.2 | 24.93 | 25.43 | 22.9 | 21.27 |
| mm | | | | | | | |
| f4(I) FS5 1.2-2.0 | % | 7.1 | 7.4 | 7.9 | 8.23 | 7.6 | 7.1 |
| mm | | | | | | | |
| f5(I) FS5 2.0-3.2 | % | 2.23 | 1.9 | 2.1 | 2.47 | 2.17 | 2 |
| mm | | | | | | | |
| f6(I) FS5 3.2-7.6 | % | 0.1 | 0.13 | 0.1 | 0.13 | 0.13 | 0.13 |
| mm | | | | | | | |
| Fiber width FS5 | μm | 11.6 | 10.7 | 10.6 | 10.5 | 10.3 | 10.8 |
| Fiber curl FS5 | % | 11.5 | 8 | 7 | 6.7 | 7.3 | 8.6 |
| Fibrillation FS5 | % | 5.15 | 4.82 | 4.29 | 4.56 | 4.91 | 5.22 |
| Kink (1/1000) | 1/1000 | 293.77 | 158.4 | 144.07 | 123.3 | 148.27 | 163.17 |
| FS5 | | | | | | | |

In view of the above detailed description of the present invention, other modifications and variations will become apparent to those skilled in the art. However, it should be apparent that such other modifications and variations may be effected without departing from the spirit and scope of the invention.

1. A process for preparing a treated fibrous material being a suspension or a wet web, the process comprising the steps of:
a) providing a suspension comprising MFC, or highly refined pulp, or a combination thereof, wherein the MFC and highly refined pulp is comprises at least 50% of solids of the suspension and wherein the suspension has a dewatering resistance measured as Schopper-Riegler (SR) value according to EN ISO 5267-1 in a range of from 72 to 99 SR°;
b) removing 2 wt-% to 25 wt-% of the solids from the suspension, wherein the content of flake-like fine material having a length less than 0.2 mm in a removed fraction is at least 50%, determined, using a Valmet Fiber Image Analyzer (FS5), as a percentage of a projection area of all measured objects in the removed fraction;
c) adjusting a solid content of the suspension from step b) to at least 2 wt % solid content;
d) subjecting fibrous material in the suspension from step c) to a heat treatment step wherein the suspension is subjected to a temperature in a range of from 50 to 150° C. for at least 10 seconds to obtain a treated fibrous material, wherein the heat treatment step is carried out on the suspension, or on a wet web formed from the suspension, or on both.

2. The process according to claim 1, wherein a pH of the suspension in step a) is in a range of from pH 4 to 8.

3. The process according to claim 1, wherein a duration of the heat treatment step is in a range of from 1 minute to 1 hour.

4. The process according to claim 1, wherein the wet web is formed by cast forming on a polymer or metal belt.

5. The process according to claim 1, wherein the heat treatment step is carried out on a wet web to provide a heat treated wet web.

6. The process according to claim 5, further comprising:
dewatering, or drying, or dewatering and drying the heat treated wet web to obtain a film.

7. A treated fibrous material obtained according to the process of claim 1.

8. The treated fibrous material according to claim 7, wherein the treated fibrous material comprises a film.

9. A paper, paperboard or film comprising:
The treated fibrous material according to claim 7.

10. A packaging material comprising:
the paper, paperboard or film according to claim 9.
